(19) United States
(12) Patent Application Publication
(10) Pub. No.: US 2024/0388071 A1
(43) Pub. Date: Nov. 21, 2024

(54) ELECTRICAL PEDESTAL

(71) Applicant: Roof Goose Vent LLC, North Kingstown, RI (US)

(72) Inventors: Jack F. KING, Jr., North Kingstown, RI (US); Stephen AUDET, Robertsdale, AL (US)

(73) Assignee: Roof Goose Vent LLC, North Kingstown, RI (US)

(21) Appl. No.: 18/668,647

(22) Filed: May 20, 2024

Related U.S. Application Data
(60) Provisional application No. 63/467,695, filed on May 19, 2023.

(51) Int. Cl. H02G 3/04; H02G 3/22

(52) U.S. Cl. CPC H02G 3/0406; H02G 3/22

(57) ABSTRACT

The invention is directed to an electrical pedestal. The electrical pedestal allows an electrician to run electrical wires through a roof without coordinating with a roofer and for mounting electrical disconnects, convenience outlets, a task light or similar device thereto. The electrical wires are enclosed in the pedestal until connection to such devices.

### RELATED APPLICATION

This application claims the benefit of U.S. Provisional Application Ser. No. 63/467,695, filed May 19, 2023, entitled “Electrical Pedestal,” which is incorporated herein by reference in its entirety.

### FIELD OF THE INVENTION

The present invention relates to an electrical pedestal. More particularly, the invention relates to an electrical pedestal which allows an electrician to run electrical feeds through a roof and then mount electrical disconnects, convenience outlets, and a task light all in a package solution.

### BACKGROUND OF THE INVENTION

Commercial construction on buildings having a flat roof requires venting and electrical terminations. A new and useful exhaust vent and electrical termination is sold by Roof Goose Vent under the trademarks ROOFGOOSEVENT® and ROOFGOOSEJACK™ and is disclosed in U.S. patent application Ser. No. 17/521,102, filed Nov. 8, 2021, entitled “Exhaust Vent And Utility Termination For HVAC Line Sets And Electrical Wires,” which application is incorporated herein by reference in its entirety.

Another fabrication on flat roofs is bringing electrical wires through the roof and requiring a termination for electrical disconnects, convenience outlets and lighting. Currently electricians are required to coordinate their electrical wiring with the roofer when bringing electrical wire through a flat commercial roof. The electrician must build a rack or a stand to hold her electrical disconnects as shown, for example, in FIG. 1. This type of electrical stand consists of a number of separate parts fabricated by the electrician, i.e. it is not a single package product. Also, pedestal products are known in the industry but are not designed for common flashings and have no provisions to allow installation without a flashing. Such pedestals are mainly seen in recreational vehicle parks or marinas. One product, a MAPA product, may be used for roofs but is not simple and easy to use and install. For example, a common roofing flashing cannot be used and requires a special split flashing for the square base of the pedestal.

The known devices have various shortcomings, including the installation of the rack or stand in coordination with the roofer. These and other shortcomings of these devices are addressed by the present invention.

### SUMMARY OF THE INVENTION

A primary object of the invention is to provide for an electrical pedestal.

Another primary object of the invention is to provide for an electrical pedestal which is waterproof and which requires no coordination with roofers for installation, thereby avoiding delays in installation.

Another primary object of the invention is to provide for an electrical pedestal which allows an electrician to pull excess wire and leave it within a cavity of the pedestal for future connection.

Another primary object of the invention is to provide for an electrical pedestal which allows an electrician to pull excess wire and leave it within a cavity of the pedestal for future connection, including a square pedestal having an interior volume large enough that an electrician can prewire up to about three units.

Another primary object of the invention is to provide for an electrical pedestal package which provides a mounting solution for disconnects, receptacles and lights.

Another primary object of the invention is to provide for an electrical pedestal which allows for common one-piece, not split, tubular flashings from the roofer.

Another primary object of the invention is to provide for an electrical pedestal for flat roofs which is elevated above snow conditions.

The electrical pedestal of the invention comprises a sleeve for carrying the electrical wires to a roof, a pedestal connected to the sleeve and mounted on the roof, and a cover attached to the top of the pedestal. A strain relief guide may be included inside the pedestal.

These primary and other objects of the invention will be apparent from the following description of the preferred embodiments of the invention and from the accompanying drawings.

### BRIEF DESCRIPTION OF THE DRAWINGS

The following detailed description of the specific non-limiting embodiments of the present invention can be best understood when read in conjunction with the following drawings, where like structures are indicated by like reference numbers.

Referring to the drawings:

FIG. 1 shows a prior art electrical stand.

FIG. 2A is a perspective view of the electrical pedestal of the invention.

FIG. 2B is a side view of FIG. 2A.

FIG. 2C is another side view of FIG. 2A.

FIG. 2D is a top view of FIG. 2A.

FIG. 3A is a perspective exploded view of FIG. 2A.

FIG. 3B is a side view of FIG. 2A.

FIG. 3C is another side view of FIG. 3A.

FIG. 4A is a perspective view of the sleeve of FIG. 2A.

FIG. 4B is a cross-sectional side view of the sleeve of FIG. 4A.

FIG. 5A is a perspective view of a first part or base of the pedestal of FIG. 2A.

FIG. 5B is a side view of FIG. 5A.

FIG. 5C is another side view of FIG. 5A.

FIG. 5D is a top view of FIG. 5A.

FIG. 6A is a perspective view of a second part or coupler of the pedestal of FIG. 2A.

FIG. 6B is a side view of FIG. 6A.

FIG. 6C is another side view of FIG. 6A.

FIG. 6D is a top view of FIG. 6A.

FIG. 7A is a perspective view of a third part or termination of the pedestal of FIG. 2A.

FIG. 7B is another perspective view of the pedestal of FIG. 2A.

FIG. 7C is a side view of FIG. 7A.

FIG. 7D is another side view of FIG. 7A.

FIG. 7E is a top view of FIG. 7A.

FIG. 8A is a perspective view of the cover of the pedestal of FIG. 2A.

FIG. 8B is another perspective view of the cover of FIG. 2A.

FIG. 8C is a side view of FIG. 8A.

FIG. 8D is another side view of FIG. 8A.

FIG. 8E is a top view of FIG. 8A.

FIG. 9A is a perspective view of the strain relief of FIG. 3A.

FIG. 9B is another perspective view of the strain relief of FIG. 9A.

FIG. 9C is a side view of FIG. 9A.

FIG. 10A is an installation of the electrical pedestal of FIG. 2A.

FIG. 10B is a perspective view of the electric pedestal of FIG. 10A.

FIG. 10C is another perspective view of the electric pedestal of FIG. 10A.

FIG. 10D is an enlarged view of section 10D of

FIG. 10A showing the termination of the pedestal.

### DETAILED DESCRIPTION OF THE PREFERRED EMBODIMENTS

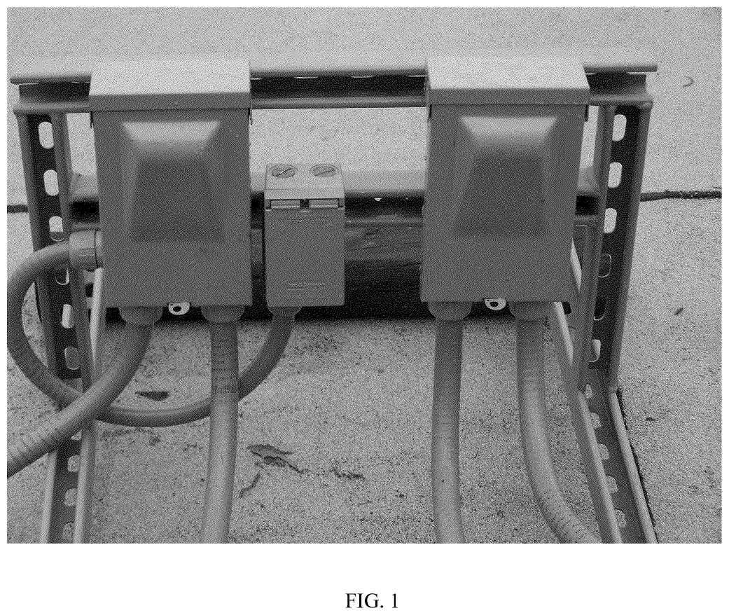

Currently electricians are required to coordinate their electrical wiring with a roofer when bringing electrical wire through a flat commercial roof. The electrician must build a rack or a stand to hold their electrical disconnects as shown in FIG. 1. While pedestal products are known in the industry, there are few for flat commercial roofs and the known pedestals have various shortcomings, including the need for special flashings.

Referring to the figures, there is shown an electrical pedestal 10. The electrical pedestal 10 includes a sleeve 12, a pedestal 14, a cover 16 and a strain relief 18. The electrical pedestal 10 is preferably made of plastic such as ASA, PVC or HDPE by injection molding. The parts of the electrical pedestal may be attached by fasteners or friction fit.

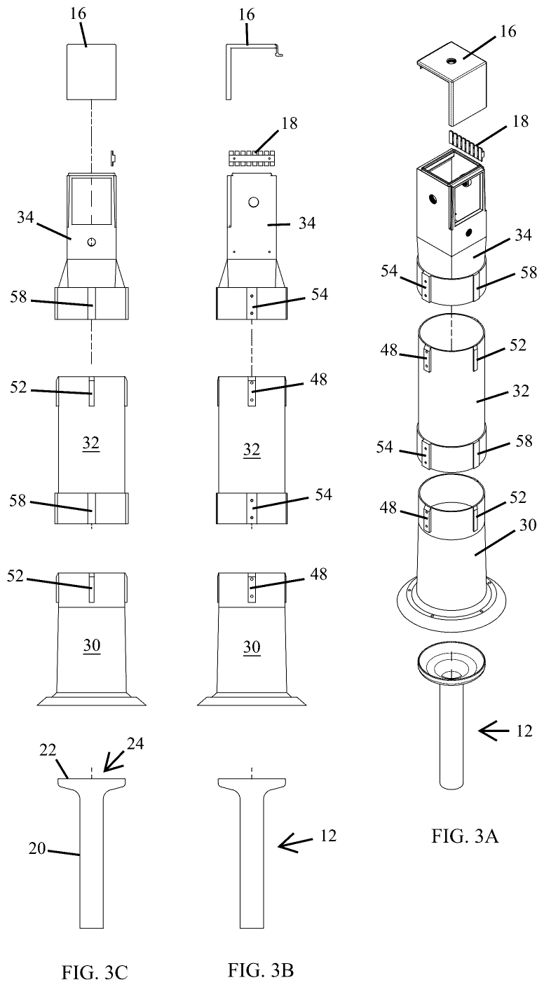

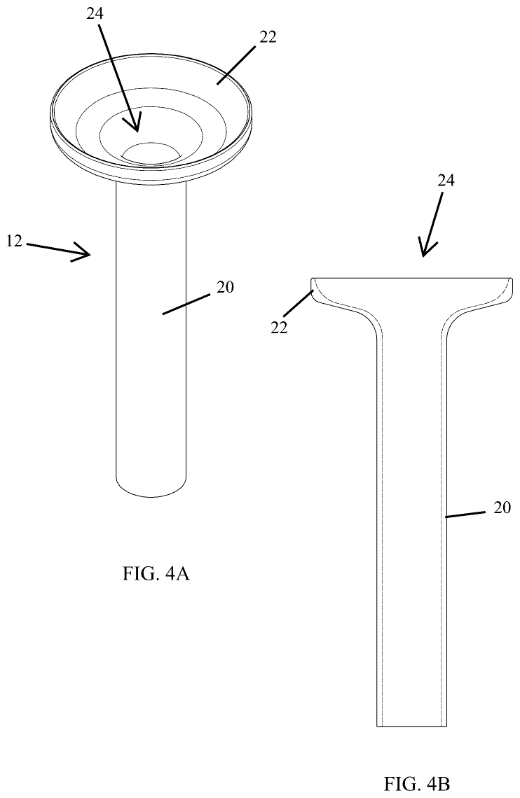

Referring, for example, to FIGS. 3A and 4A, sleeve 12 includes a tubular portion 20 through which electrical wiring is run. Sleeve 12 further includes a funnel shape end 22 having an opening 24 through which electrical wires run. The sleeve 12 projects through the roof and seats against the underside of the pedestal 14 and is attached to the bottom of pedestal 14, e.g. by a wedge lock.

Referring, for example, to FIG. 3A, pedestal 14 is preferably three parts, a first part or base 30, a second part or coupler 32 and a third part or termination 34. The use of multiple parts allows for adjustment of the height of the pedestal; provides rigidity to the pedestal; allows the base 30 to be used in different applications; and allows for easier shipping of the product. However, the pedestal may be one part or any number of parts without departing from the scope of the invention. Each of these parts may be connected by mechanical fasteners, tongue and groove, friction fit or other means.

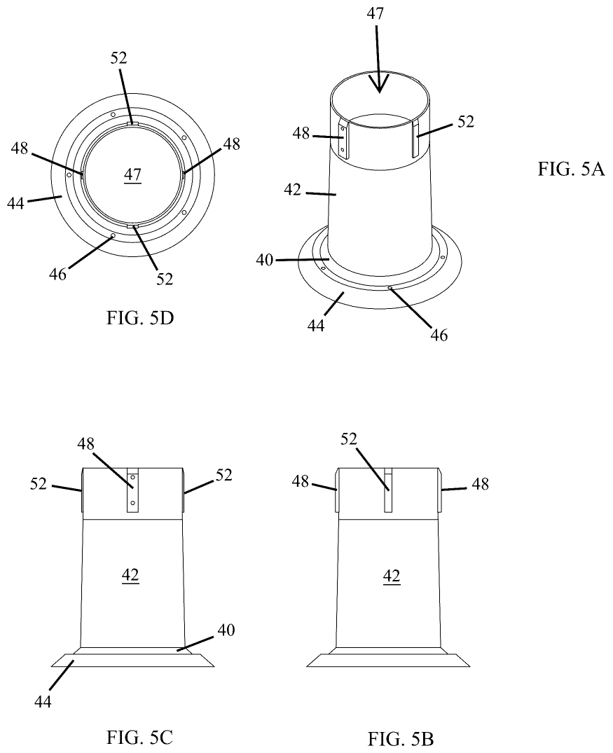

Referring, for example, to FIGS. 3 and 5, base 30 has a rounded base 40 which transitions to a round tube 42. Base 40 includes a flashing gasket 44. Flashing gasket 44 is attached to roof R by fasteners, e.g. screws, through apertures 46. The top of base 30 includes an opening 47 for communication with coupler 32 and two vertical rectangular connectors 48 having apertures 50 and two upraised vertical members 52. Connectors 48 and members 52 are adapted to mate with corresponding connection members of coupler 32 as discussed hereafter.

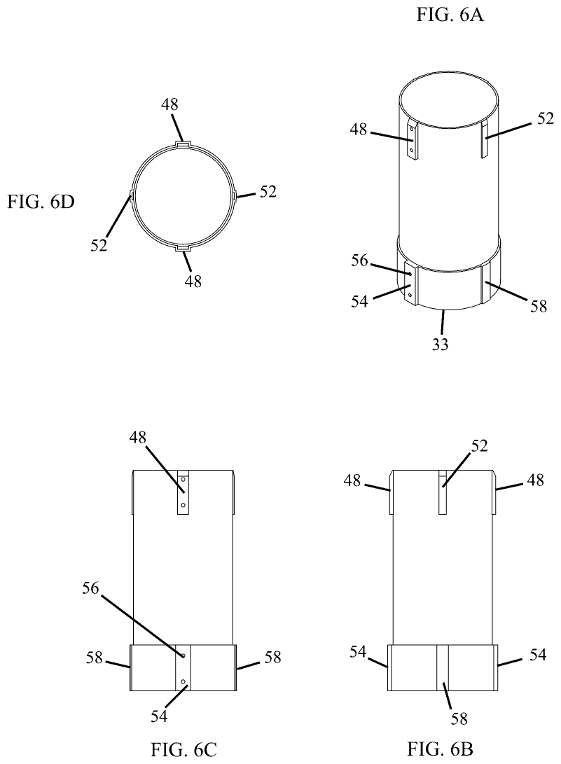

Referring, for example, to FIGS. 3 and 6, coupler 32 is tubular and includes at a bottom end 33 two vertical connectors 54 having apertures 56 and correspond to connectors 48 of the base. Coupler 32 also includes two channels 58 which corresponds to vertical upraised members 52. Coupler 32 fits over base 30. Channels 58 and upraised members 52 align coupler 32 for attachment to base 30. Fasteners are used to connect connectors 54 of the coupler to connectors 48 of the base. At the top of coupler 32 are connectors 48 and upraised vertical members 52 for connecting coupler 32 to termination 34 in a similar manner.

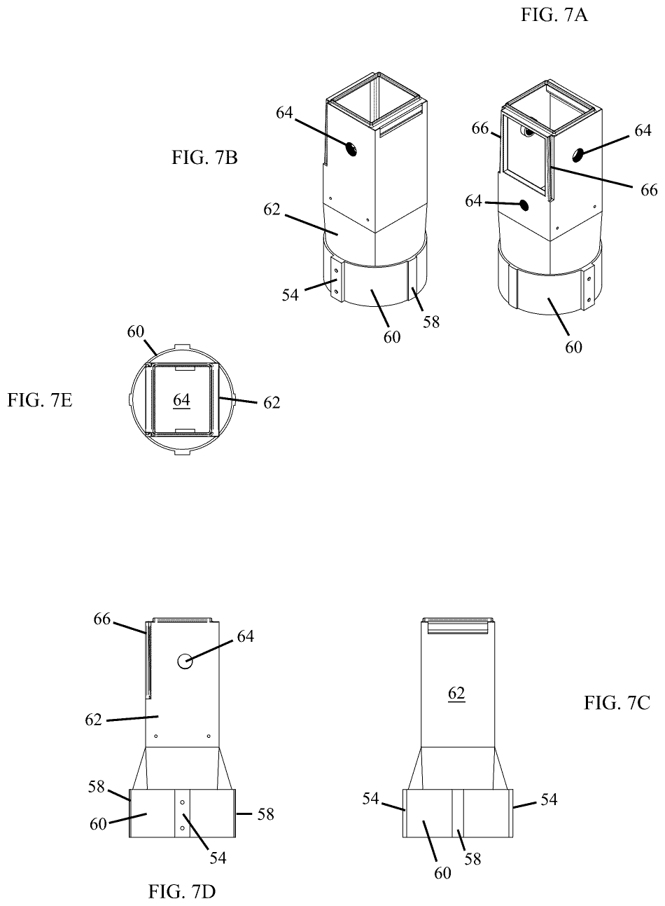

Referring, for example, to FIGS. 3 and 7, termination 34 includes a tubular bottom portion 60 with two connectors 54 and channels 58 for connection of termination 34 to coupler 32. Termination 34 fits over coupler 32. Bottom portion 60 transitions to a square portion 62 having openings 64 through which electrical wires may extend for attaching electrical disconnects, convenience outlets, lights or similar articles to termination 34. At the top of termination 34 there are grooves 66 for receiving and attaching cover 16 to termination 34 to enclose termination 34. Other known means may be used to attach cover 16 to pedestal 14.

After electrical pedestal 14 is installed, a common roofing flashing (not shown) will be installed by the roofer over flashing gasket 44 to seal the electrical pedestal.

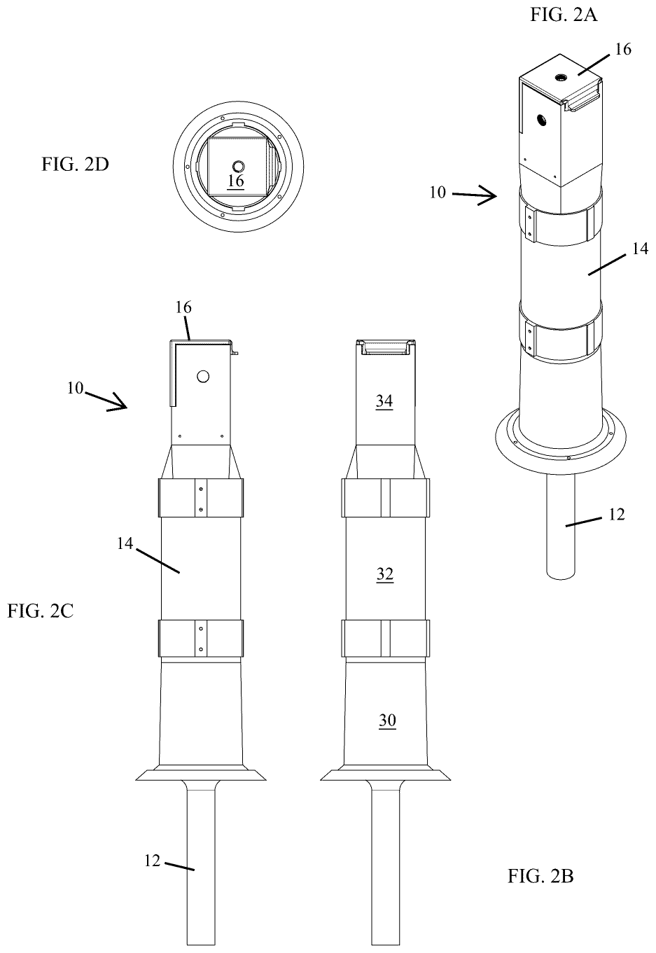

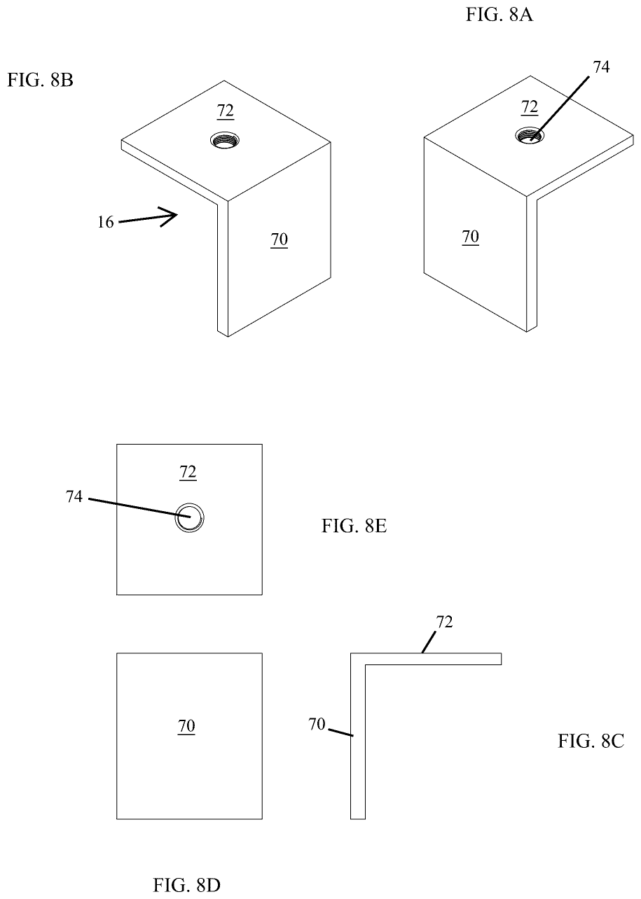

Referring, for example, to FIGS. 2A, 3A and 8A, cover 16 is L-shaped and includes a side wall 70 and a top wall 72. Top wall 72 has an opening 74 for installation of a task light (not shown).

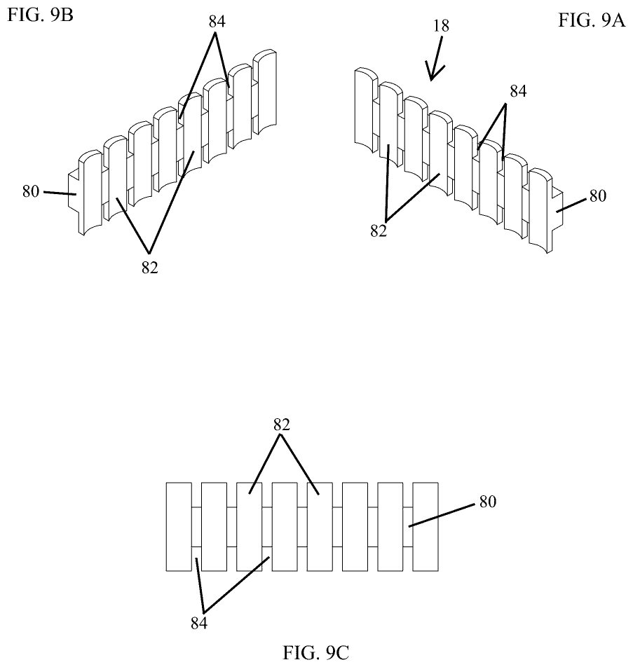

Referring, for example, to FIGS. 2A, 3A and 9A, strain relief 18 is attached inside termination 34 of pedestal 14 for receiving electrical wires. Strain relief 18 includes a base section 80 having fingers 82 with slots 84 between fingers 82. Electrical wire may fit into slots 84. It is understood that one or more stain reliefs 18 may be used.

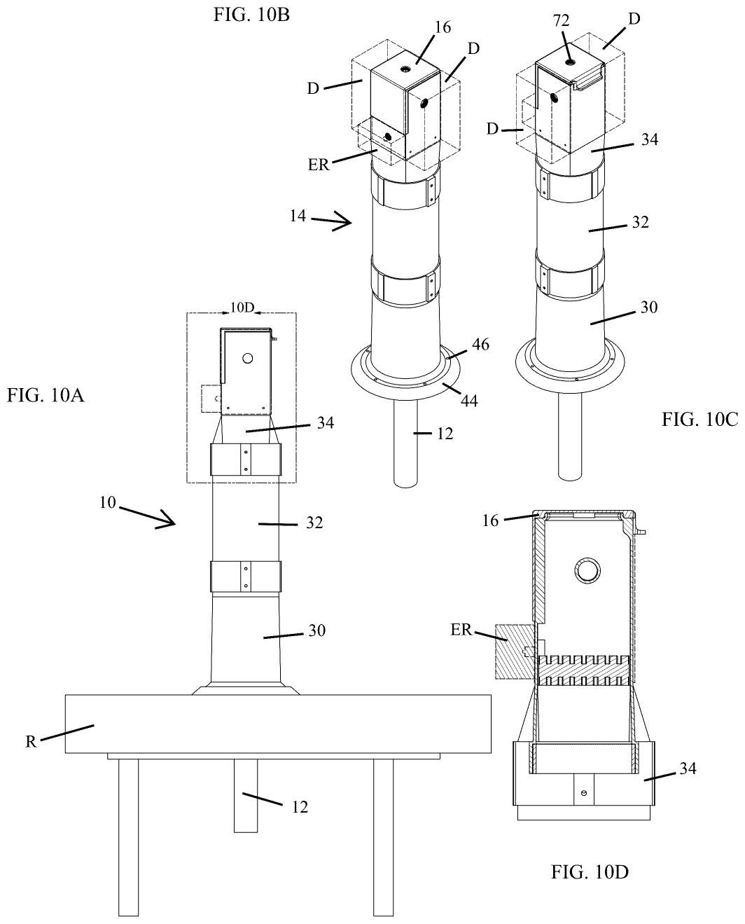

Referring to FIG. 10A-10D, there is shown an installation of the electrical pedestal 10. Referring to FIG. 10A, there is shown a flat roof R. In use, sleeve 12 extends below roof R and through which electrical wires (not shown) are passed. Sleeve 12 mates with pedestal 14. The pedestal 14 is attached to roof R by fasteners at flashing gasket 44. The electrical wires are passed up through pedestal 14 to termination 34. Cover 16 is attached to termination 34 and the wires are thereby available to an electrician for connecting electrical disconnects, convenience outlets, lighting or other such devices. Referring to FIGS. 10A-10D, there are illustrated two electrical disconnects D and an electrical receptacle ER.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

1. An electrical pedestal comprising a sleeve adapted to carry electrical wires to a flat roof, a pedestal adapted to be connected to the sleeve and mounted on the flat roof, a cover adapted to be attached to the top of the pedestal, and optionally a strain relief adapted to be attached to the inside of the pedestal.

2. The electrical pedestal according to claim 1 wherein the sleeve, the pedestal and the cover are made of plastic.

3. The electrical pedestal according to claim 1 wherein the pedestal is adapted to receive a one-piece tubular flashing.

4. The electrical pedestal according to claim 2 wherein the pedestal is adapted to receive a one-piece tubular flashing.

5. The electrical pedestal according to claim 1 wherein the electrical pedestal is adapted to receive the electrical wires to wire at least two devices selected from the group consisting of an electrical disconnect, a convenience outlet, a light or a combination thereof.

6. The electrical pedestal according to claim 1 wherein the sleeve is plastic and comprises a tubular portion and a funnel shaped end.

7. The electrical pedestal according to claim 6 wherein the pedestal is plastic and comprises at least two parts consisting of a tubular base having a flashing at one end thereof adapted to overlie and be connected to the sleeve and an upper end having a square or rectangular portion adapted to receive at least two devices selected from the group consisting of an electrical disconnect, a convenience outlet, a light or a combination thereof.

8. The electrical pedestal according to claim 7 wherein the cover includes an opening for attaching a light.

9. The electrical pedestal according to claim 8 wherein the electrical pedestal is adapted to receive two electrical disconnects, one convenience outlet and a light.

10. The electrical pedestal according to claim 1 further comprising the strain relief.

11. The electrical pedestal according to claim 1 adapted to be installed by an electrician and left for later installation of a one-piece tubular flashing by a roofer.

12. An electrical pedestal comprising a plastic sleeve adapted to carry electrical wires to a flat roof comprising a tubular portion and a funnel shaped end; a plastic pedestal adapted to be connected to the sleeve and mounted on the flat roof comprising a tubular end having a flashing and the tubular end transitioning to a square or rectangular end adapted to receive the electrical wires and adapted to wire at least two devices selected from the group consisting of an electrical disconnect, a convenience outlet, a light or a combination thereof; a plastic cover adapted to be attached to the top of the pedestal; and optionally a strain relief adapted to be attached to the inside of the pedestal, wherein the electrical pedestal is adapted to receive a one-piece tubular flashing overlying the flashing of the pedestal.

13. The electrical pedestal according to claim 12 further comprising the strain relief.

14. The electrical pedestal according to claim 13 adapted to be installed by an electrician and left for later installation of the one-piece tubular flashing by a roofer.

15. The electrical pedestal according to claim 14 wherein the electrical pedestal is adapted to receive two electrical disconnects, one convenience outlet and a light.
